(19) United States
(12) Patent Application Publication
(10) Pub. No.: US 2021/0155062 A1
(43) Pub. Date: May 27, 2021

(54) TOWING HITCH WITH CLEARANCE FOR USE WITH STEP-EQUIPPED TAILGATES

(71) Applicant: Joseph DRURY, Friendswood, TX (US)

(72) Inventor: Joseph DRURY, Friendswood, TX (US)

(21) Appl. No.: 16/950,024

(22) Filed: Nov. 17, 2020

Related U.S. Application Data
(60) Provisional application No. 62/940,065, filed on Nov. 25, 2019.

(51) Int. Cl. B60D 1/52; B60D 1/46; B60D 1/06

(52) U.S. Cl. CPC B60D 1/52; B60D 1/065; B60D 1/46

(57) ABSTRACT

Embodiments disclosed herein relate to apparatus and methods for a stowable towing hitch for a towing vehicle with a step-equipped tailgate. Embodiments of the stowable towing hitch allow unencumbered utilization of the step-equipped tailgate without the need to remove the stowable towing hitch from the towing vehicle.

### CROSS-REFERENCE TO RELATED APPLICATION

This application claims priority to U.S. Provisional Patent Application Ser. No. 62/940,065, filed Nov. 25, 2019, which is hereby incorporated by reference herein.

### BACKGROUND

### Field

Embodiments disclosed herein relate to a towing hitch that mounts securely onto a receiver hitch of a towing vehicle, and adjusts and/or folds to provide clearance behind the towing vehicle. In particular, towing hitches that are designed for use with step-equipped tailgates but can be used on most vehicles having conventional receiver hitches.

### Description of the Related Art

Towing hitches are devices used to attach a trailer to a towing vehicle. The most common type of hitch for recreation and/or work vehicles is the bumper pull. On this type of hitch, a tongue of a trailer is attached to a receiver hitch that is accessible from a rear end of the towing vehicle. The towing hitch is commonly inserted into the receiver hitch that is attached to a frame of the towing vehicle.

There are several common problems with this style of towing hitch. The first problem is hitch height. The towing hitch may need to be at several heights to accommodate various vehicle receiver hitch heights as well as various trailer tongue heights. A second problem is that towing hitches can move around or rattle in the receiver hitch. A third problem is that an installed towing hitch protrudes from the rear end of the towing vehicle which may create safety issues as well as other problems. For example, the protruding hitch is an obstacle and may cause parking issues, such as when parking in garages and/or near other vehicles. The protruding hitch could also cause clearance issues with step-equipped tailgates on some vehicles. These step-equipped tailgates require that the towing hitch be removed from the towing vehicle before utilizing some functions of the step-equipped tailgate.

What is needed is a towing hitch that alleviates one or more of the problems discussed above.

### SUMMARY

Embodiments of the disclosure include a towing hitch that includes one or more features that allow use thereof with a step-equipped tailgate. In one embodiment, the towing hitch includes a mounting plate that has a profile that is recessed from conventional hitches thus providing a critical clearance enabling utilization of a step-equipped tailgate without removing the towing hitch from the vehicle.

In another embodiment, a towing hitch is disclosed that includes a mounting plate coupled to a tubular insert that is couplable to a tubular receiver member on a towing vehicle having a step-equipped tailgate, and a hitch plate coupled to the mounting plate by a hinge mechanism, the hitch plate adapted to secure a trailer ball, wherein the hinge mechanism is coupled to the mounting plate by a pivot pin that allows rotation of the hitch plate relative to the mounting plate to a stowed position such that a critical clearance between the step-equipped tailgate and the mounting plate is provided.

In another embodiment, a towing hitch is disclosed that includes a mounting plate coupled to a tubular insert that is couplable to a tubular receiver member on a towing vehicle having a step-equipped tailgate, and a hitch plate coupled to the mounting plate by a hinge mechanism, the hitch plate adapted to secure a trailer ball, wherein the hinge mechanism is coupled to the mounting plate by a pivot pin and one or more stabilizing pins, wherein by removing the one or more stabilizing pins rotation of the hitch plate relative to the mounting plate is provided such that utilization of the step-equipped tailgate is enabled without removing the tubular insert from the towing vehicle.

In another embodiment, a towing hitch is disclosed that includes a mounting plate coupled to a tubular insert that is couplable to a tubular receiver member on a towing vehicle having a step-equipped tailgate, and a hitch plate coupled to the mounting plate by a hinge mechanism, the hitch plate adapted to secure a trailer ball, wherein the hinge mechanism is coupled to the mounting plate by a pivot pin that allows rotation of the hitch plate relative to the mounting plate to a stowed position such that utilization of the step-equipped tailgate is enabled without removing the tubular insert from the towing vehicle.

### BRIEF DESCRIPTION OF DRAWINGS

The drawings present typical embodiments of the disclosure but should not be considered limiting in scope.

FIG. 1 is a side view of a towing vehicle with an exemplary step-equipped tailgate.

FIG. 2 is a sectional view of a receiver hitch having one embodiment of a stowable towing hitch installed therein.

FIG. 3 is an isometric view of the mounting plate of the stowable hitch of FIG. 2.

FIG. 4 is a side view of the receiver hitch having the stowable towing hitch of FIG. 2 installed therein.

FIG. 5 is an isometric view of the receiver hitch having the stowable towing hitch of FIG. 2 installed therein.

FIG. 6 shows the stowable towing hitch of FIG. 2 in a stowed position.

FIG. 7 shows another embodiment of a stowed position of the stowable towing hitch of FIG. 2.

FIGS. 8 and 9 are various views of another embodiment of a stowable towing hitch that enables use of a step-equipped tailgate as described herein.

FIG. 10 shows another embodiment of a towing hitch that enables use of a step-equipped tailgate as described herein.

FIG. 11 is an isometric view of a portion of another embodiment of a towing hitch that enables use of a step-equipped tailgate as described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments disclosed herein include multiple configurations of a stowable towing hitch that has particular utility for use with a towing vehicle having a step-equipped tailgate or “multi-function” tailgate. A step-equipped or “multi-function” tailgate can be generally described as having a primary gate and a smaller internal gate incorporated within the primary gate. The primary gate is hinged like a conventional tailgate. Then, the internal gate is hinged within the primary gate panel. When a person raises or lowers these two gates in different combinations, the internal gate acts as a step. A step-equipped or “multi-function” tailgate includes tailgates marketed by General Motors Company under the tradename “MultiPro” as well as other similar tailgates from other vehicle manufacturers. The components of the various embodiments disclosed herein can be arranged in several configurations to cover a wide range of vehicles and trailers. The figures are not intended to limit the scope of the invention.

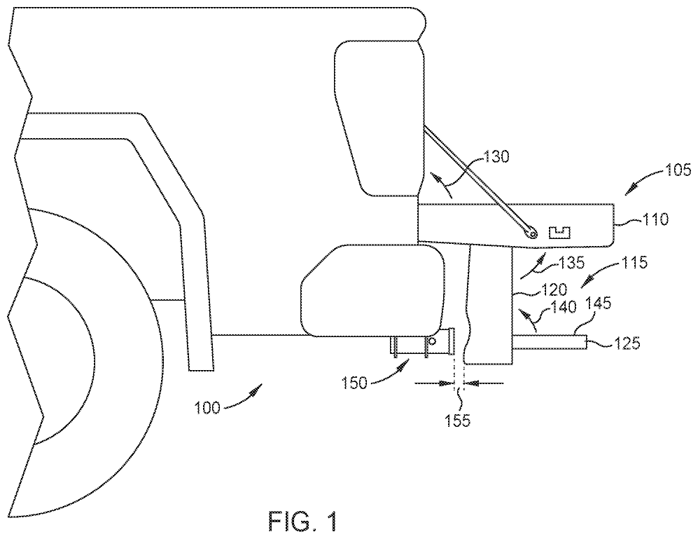

FIG. 1 shows a towing vehicle 100 having a step-equipped tailgate 105. The step-equipped tailgate 105 includes a primary gate 110 with an internal gate device 115. The internal gate device 115 includes a first hinged panel 120 and a second hinged panel 125. The primary gate 110 is shown as being open and moves to a closed position in the direction of arrow 130. The first hinged panel 120 is shown as being open and moves to a closed position in the direction of arrow 135. The second hinged panel 125 is shown as being open and moves to a closed position toward the first hinged panel 120 in the direction of arrow 140. In the open position, the second hinged panel 125 functions as a step 145.

The towing vehicle 100 also includes a receiver hitch 150 that is adapted to receive a towing hitch (not shown in FIG. 1). In this configuration, the towing hitch is removed from the receiver hitch 150 in order to accommodate the step-equipped tailgate 105 in the open position. For example, a critical clearance (e.g., a protrusion or protruded distance) 155 is present when the step-equipped tailgate 105 is in the open position as shown. If a towing hitch was installed in the receiver hitch 150 when using the step-equipped tailgate 105 as shown, the towing hitch would damage the step-equipped tailgate 105 and/or prevent proper operation of the step-equipped tailgate 105. As such, a user must remove the towing hitch to enjoy full use of the step-equipped tailgate 105. In most cases, the critical clearance 155 is less than 1 inch (measured between a surface of the first hinged panel 120 facing the towing vehicle 100 and the receiver hitch 150). This critical clearance 155 is too small for conventional towing hitches to remain coupled to the receiver hitch 150 when using the step-equipped tailgate 105 as shown in FIG. 1.

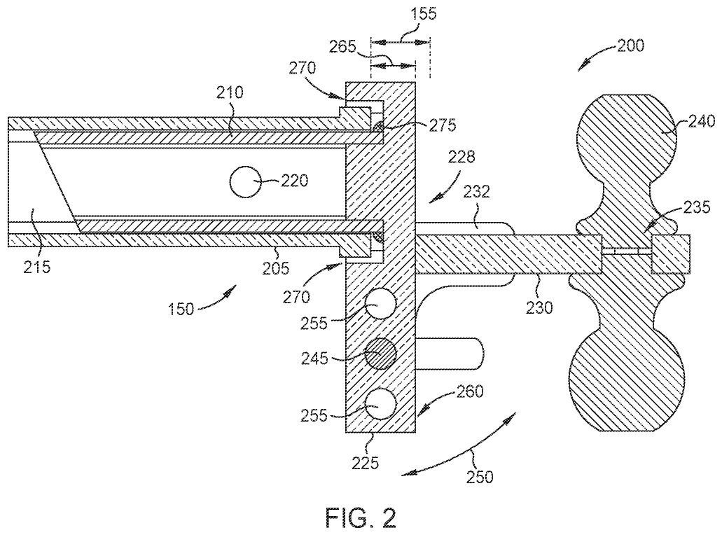

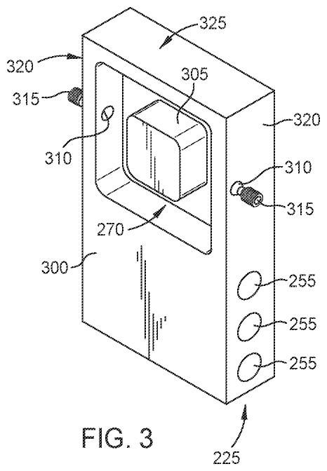

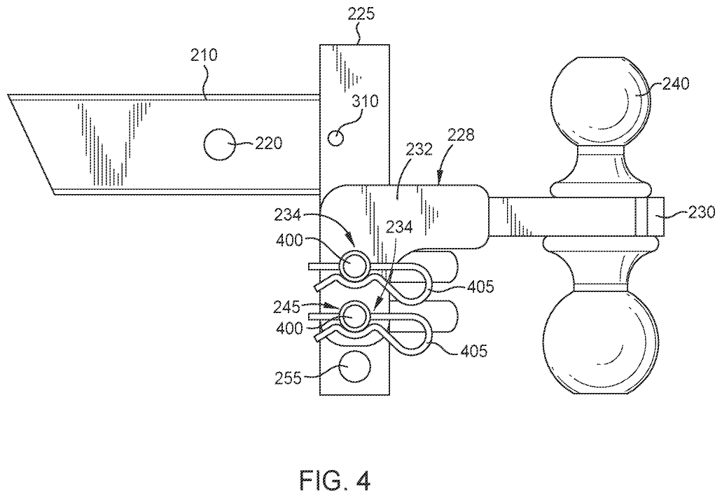

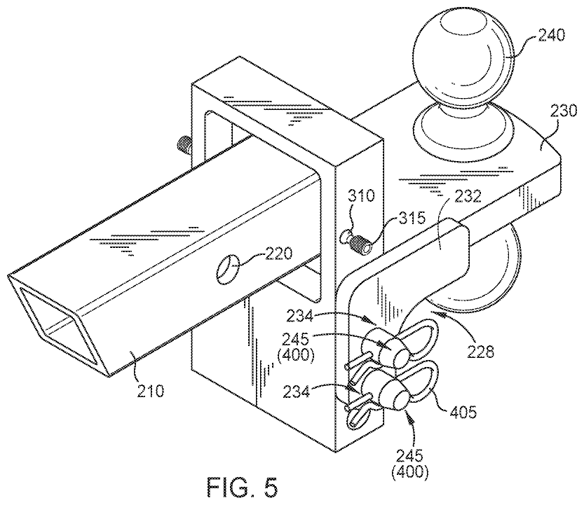

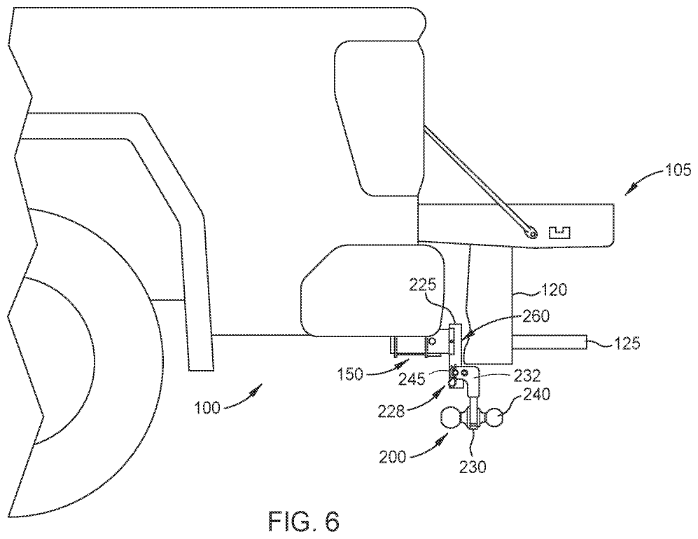

FIGS. 2-6 are various views of an embodiment of a stowable towing hitch 200 according to embodiments disclosed herein. FIG. 2 is a sectional view of the receiver hitch 150 having the stowable towing hitch 200 installed therein. FIG. 3 is an isometric view of the mounting plate 225. FIGS. 4 and 5 are a side view and an isometric view, respectively, of the receiver hitch 150 having the stowable towing hitch 200 installed therein. FIG. 6 shows one embodiment of the stowable towing hitch 200 in a stowed position.

The receiver hitch 150 includes a tubular receiver member 205 that is typically rectangular metal tubing. The tubular receiver member 205 typically has an end that extends or protrudes past a rear of the towing vehicle 100 (shown in FIG. 1). The stowable towing hitch 200 includes a tubular hitch member 210 (e.g., a tubular insert portion) that is inserted into a volume 215 of the tubular receiver member 205. Similar to the tubular receiver member 205, the tubular hitch member 210 is typically rectangular metal tubing that is sized slightly smaller than an inside dimension of the tubular receiver member 205. A through-hole 220 is provided in both of the tubular receiver member 205 and the tubular hitch member 210. The through-holes 220 are sized to receive a pin (not shown) that secures the stowable towing hitch 200 to the receiver hitch 150 when the through-holes 220 in both of the tubular receiver member 205 and the tubular hitch member 210 are aligned.

The stowable towing hitch 200 includes a mounting plate 225 that is fixed or fastened to the tubular hitch member 210. The mounting plate 225 supports a hinge mechanism 228. A hitch plate 230 having a through-hole 235 where a trailer ball 240 (two are shown) is fastened to the hinge mechanism 228. The hinge mechanism 228 includes two L shaped brackets 232. The hitch plate 230 is fastened to one leg of the L shaped brackets 232 such as by a weld (not shown). The mounting plate 225 is sandwiched between the other leg of the L shaped brackets 232.

Referring to FIGS. 2, 4 and 5, the mounting plate 225 includes a plurality of openings 255 formed therethrough in a direction parallel to the through-holes 220 (e.g., in a “cross-machine” direction). The hinge mechanism 228 also includes one or more through-holes 234 that align with the openings 255 formed in the mounting plate 225. The hinge mechanism 228 includes a pivot pin 245 disposed in one of the openings 255 of the mounting plate 225 (and the through-holes 234 of the hinge mechanism 228). The pivot pin 245 allows the hinge mechanism 228 (including the hitch plate 230 and the trailer ball 240) to pivot relative to the mounting plate 225 in the direction of arrow 250. Thus, in the position shown in FIG. 2, one or more stabilizing pins 400 (shown in FIGS. 4 and 5) may be inserted into other openings 255 formed in the mounting plate 225 adjacent to the opening 255 where the pivot pin 245 is located, and the stowable towing hitch 200 may be used for towing a trailer. However, when the one or more stabilizing pins 400 are removed, the hinge mechanism 228 allows the stowable towing hitch 200 to pivot out of the way such that the step-equipped tailgate 105 may be opened as shown in FIG. 6. Each of the pivot pin 245 and the one or more stabilizing pins 400 are secured to the mounting plate 225 by a retainer 405, such as a cotter pin.

Referring again to FIG. 2, the mounting plate 225 includes a protruding surface 260 that is well within the critical clearance 155 allowing use of the step-equipped tailgate 105. For example, a distance 265 that the mounting plate 225 protrudes from a distal end (i.e., a protruding end) of the receiver hitch 150 is less than the critical clearance 155.

Referring to FIGS. 2 and 3, the mounting plate 225 includes a pocket 270 that is formed in a rear surface 300 of thereof. The pocket 270 may be formed by milling. A block insert 305 is formed by the inner perimeter of the pocket 270. The block insert 305 extends a short distance into an inside dimension of the tubular hitch member 210 as shown in FIG. 2. The tubular hitch member 210 is then fastened to the mounting plate 225 (e.g., by a weld 275 (shown in FIG. 2)). The pocket 270 and the block insert 305 may be formed by a machining method, such as a milling process. Alternatively, the mounting plate 225 and hitch member 210 may be formed as one piece by casting or milling from a solid material. The pocket 270 allows the mounting plate 225 to at least partially cover and/or surround the protruding end of the tubular receiver member 205.

Referring to FIGS. 3-5, according to one embodiment, the mounting plate 225 of the stowable towing hitch 200 includes one or more holes 310 each configured to receive a stabilizing fastener 315. Each stabilizing fastener 315 is a screw or bolt adapted to thread into the holes 310 and extend through the pocket 270, and tighten against an outer surface of the tubular receiver member 205 of the receiver hitch 150 (shown in FIG. 2). When the stabilizing fastener(s) 315 are tightened, the stabilizing fastener(s) 315 minimize movement of the mounting plate 225 during use relative to the tubular receiver member 205. When the stowable towing hitch 200 is to be removed from the receiver hitch 150, the stabilizing fastener(s) 315 may be loosened. The holes 310 are shown in a side surfaces 320 (opposing minor sides) of the mounting plate 225. Alternatively or additionally, one or more holes (not shown) may be formed in a top surface 325 of the mounting plate 225 (shown in FIG. 3), each adapted to receive a stabilizing fastener 315.

FIG. 6 shows one embodiment of the stowable towing hitch 200 in a stowed position. In this Figure, the hinge mechanism 228 is rotated about 90 degrees from the position shown in FIGS. 2, 4 and 5. In the position shown, the hitch plate 230 and the trailer ball 240, as well as a plurality of L-shaped brackets 232 (of the hinge mechanism 228), are spaced apart from surfaces of the step-equipped tailgate 105. Thus, the step-equipped tailgate 105 is operable without removing the stowable towing hitch 200 from the towing vehicle 100.

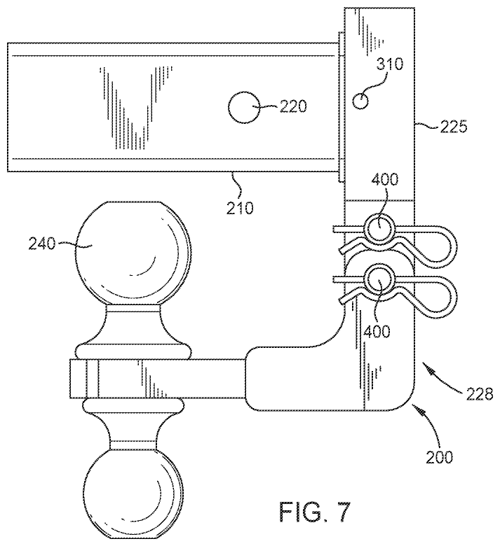

FIG. 7 shows another embodiment of a stowed position of the stowable towing hitch 200. In FIG. 7, the orientation of the hinge mechanism 228 is reversed from what would be a towing position as opposed to merely rotating the hinge mechanism 228 as shown in FIG. 6. In either of the orientations shown in FIGS. 6 and 7, the critical clearance 155 is achieved such that the step-equipped tailgate 105 may be utilized as shown in FIG. 1 without removing the stowable towing hitch 200 from the towing vehicle 100. In this embodiment, the hinge mechanism 228 is rotated about 180 degrees from the position shown in FIGS. 2, 4 and 5.

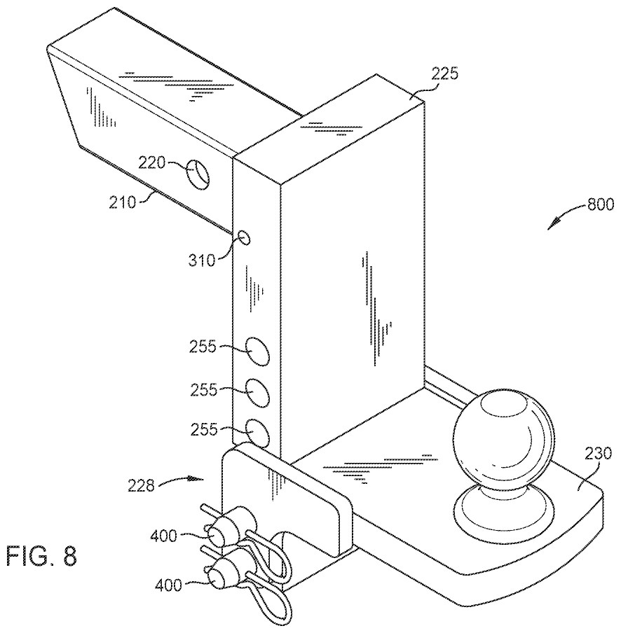

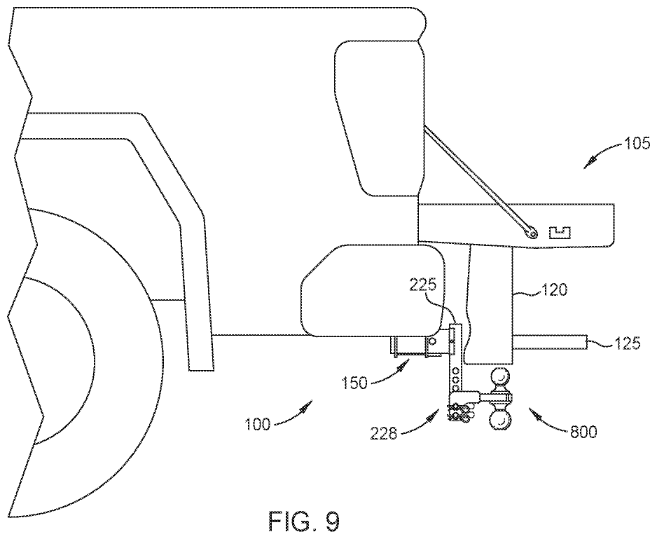

FIGS. 8 and 9 are various views of another embodiment of a stowable towing hitch 800 as described herein. The stowable towing hitch 800 is similar to the stowable towing hitch 200 described above with the exception of additional openings 255 formed in the mounting plate 225. The additional openings 255 provides for additional height adjustment of the hitch plate 230 for various vehicle and/or trailer tongue heights. FIG. 9 shows the stowable towing hitch 800 in a position such that the step-equipped tailgate 105 may be utilized.

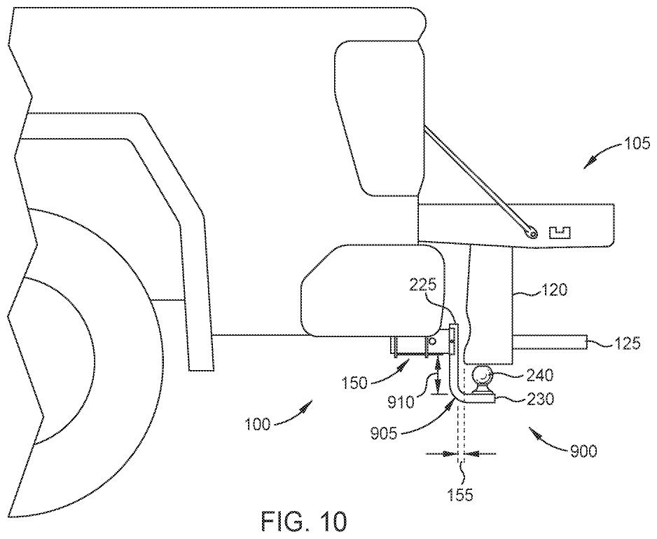

FIG. 10 shows another embodiment of a towing hitch 900 that includes the mounting plate 225 as described herein. The towing hitch 900 includes an interface 905 where the hitch plate 230 and the mounting plate 225 are joined. The interface 905 is provided at a depth 910 where the trailer ball 240 is at a location that allows use of the step-equipped tailgate 105 in the open position as shown. The depth 910 may also be provided to accommodate various vehicle and/or trailer tongue heights.

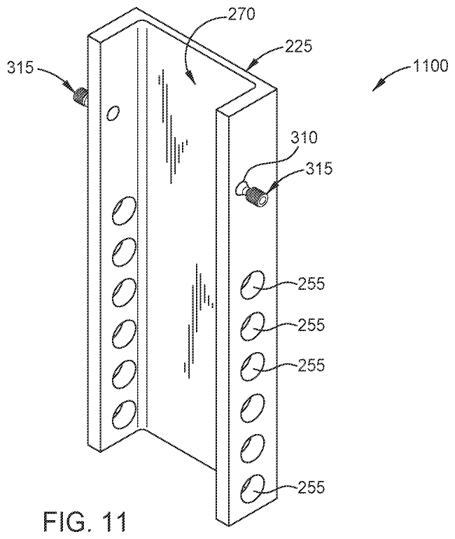

FIG. 11 is an isometric view of a portion of another embodiment of a towing hitch 1100. The partial towing hitch 1100 includes another version of a mounting plate 225 that enable use of the hitch with a step-equipped tailgate 105. In this embodiment, the mounting plate 225 includes an extended pocket 270 that is utilized to couple to the tubular hitch member 210 (not shown) as described and shown in FIG. 2. The mounting plate 225 is adapted to receive the hinge mechanism 228 (not shown) as described herein. The pocket 270. according to this embodiment, extends along a height or length dimension of the mounting plate 225. While not shown, a block insert 305 (shown in FIG. 3) may be included within the pocket 270. The entire mounting plate 225 could milled for the recess (pocket 270) around the receiver or made from a casting, rolled or forged configuration such as shown in FIG. 11.

While the foregoing is directed to embodiments of the present disclosure, other and further embodiments of the disclosure may be devised without departing from the basic scope thereof, and the scope thereof is determined by the claims that follow.

1. A towing hitch, comprising:
a mounting plate having a hitch plate coupled thereto, the mounting plate having a recessed pocket that allows the mounting plate of the towing hitch to fit over an end of a tubular receiver of a towing vehicle having a step-equipped tailgate to reduce a protrusion of the hitch plate when coupled to the tubular receiver member on the towing vehicle.

2. The towing hitch of claim 1, wherein the mounting plate has a tubular or solid insert within the recessed pocket that fits into the tubular receiver of the towing vehicle, and hitch plate is secured to the mounting plate with a pin.

3. The towing hitch of claim 1, wherein the mounting plate is coupled to a tubular insert member that is inserted into the tubular receiver of the towing vehicle, and the mounting plate and the tubular insert member comprises a metal casting or is milled from a single piece of material.

4. The towing hitch of claim 1, wherein the mounting plate is coupled to a tubular insert member that is inserted into the tubular receiver of the towing vehicle, and the mounting plate and the tubular insert member are attached by a weld in the recessed pocket.

5. The towing hitch of claim 1, wherein the mounting plate includes a plurality of openings formed therethrough in a cross-machine direction, each of the openings adapted to receive a pivot pin and one or more stabilizing pins.

6. The towing hitch of claim 5, further comprising a plurality of brackets coupling the mounting plate to the hitch plate, wherein each of the brackets include one or more through-holes that align with one or more of the plurality of openings in the mounting plate each of the through-holes adapted to receive one or more stabilizing pins.

7. A towing hitch for a towing vehicle having a step-equipped tailgate, the towing hitch comprising:
a hitch plate coupled to a mounting plate by a hinge mechanism, the hitch plate adapted to secure a trailer ball, wherein the hinge mechanism is coupled to the mounting plate by a pivot pin that allows removal or rotation of the hitch plate relative to the mounting plate to a stowed position such that a critical clearance between the step-equipped tailgate and the mounting plate is provided.

8. The towing hitch of claim 7, wherein the mounting plate includes a recessed pocket formed therein.

9. The towing hitch of claim 8, wherein the mounting plate has a tubular or solid insert within the recessed pocket that fits into a tubular receiver of the towing vehicle, and hitch plate is secured to the mounting plate with a plurality of pins.

10. The towing hitch of claim 9, wherein the mounting plate is coupled to a tubular insert member that is inserted into the tubular receiver of the towing vehicle, and the mounting plate and the tubular insert member comprises a metal casting or is milled from a single piece of material.

11. The towing hitch of claim 9, wherein the mounting plate is coupled to a tubular insert member that is inserted into the tubular receiver of the towing vehicle, and the mounting plate and the tubular insert member are attached by a weld in the recessed pocket.

12. A towing hitch, comprising:
a mounting plate coupled to a tubular insert portion that is couplable to a tubular receiver member on a towing vehicle having a step-equipped tailgate; and
a hitch plate coupled to the mounting plate by a hinge mechanism, the hitch plate adapted to secure a trailer ball, wherein the hinge mechanism is coupled to the mounting plate by a pivot pin that allows rotation of the hitch plate relative to the mounting plate to a stowed position such that a critical clearance between the step-equipped tailgate and the mounting plate is provided.

13. The towing hitch of claim 12, wherein the mounting plate further comprises a recessed pocket formed in a surface thereof facing the tubular insert portion.

14. The towing hitch of claim 13, wherein the pocket includes a block that is at least partially within the tubular insert portion.

15. The towing hitch of claim 13, wherein a weld is provided about a periphery of the tubular insert portion within the recessed pocket.

16. The towing hitch of claim 12, wherein the hinge mechanism includes a plurality of L-shaped brackets that are fixed to the hitch plate.

17. The towing hitch of claim 16, wherein the mounting plate includes a plurality of openings formed therethrough in a cross-machine direction, each of the openings adapted to receive the pivot pin and one or more stabilizing pins.

18. The towing hitch of claim 17, wherein each of the L-shaped brackets include one or more through-holes that align with one or more of the plurality of openings in the mounting plate each of the through-holes adapted to receive the pivot pin and the one or more stabilizing pins.

19. The towing hitch of claim 12, wherein the stowed position comprises rotating the hinge mechanism 90 degrees relative to a towing position.

20. The towing hitch of claim 12, wherein the stowed position comprises rotating the hinge mechanism 180 degrees relative to a towing position.
